(19) United States
(12) Patent Application Publication
(10) Pub. No.: US 2012/0308851 A1
(43) Pub. Date: Dec. 6, 2012

(54) FUEL CELL SYSTEM AND METHOD FOR CONTROLLING THE SAME

(76) Inventor: Takashi Akiyama, Osaka (JP)

(21) Appl. No.: 13/575,761

(22) PCT Filed: Oct. 13, 2011
(86) PCT No.: PCT/JP2011/005726

§ 371 Date: Jul. 27, 2012

(30) Foreign Application Priority Data
Dec. 17, 2010 (JP) 2010-281911

(51) Int. Cl. H01M 8/04; H01M 16/00

(52) U.S. Cl. 429/9; 429/428

(57) ABSTRACT

A method is provided for controlling a fuel cell system including a fuel cell and a secondary battery for storing output power thereof. The method includes the steps of: detecting a remaining capacity of the secondary battery; determining a rate of change of the remaining capacity, where the rate of change is defined as positive when it increases and negative when it decreases; and changing an operation state of the fuel cell based on the remaining capacity and the rate of change. The step of changing the operation state is, for example, a step of switching the operation state between a plurality of power generation modes based on the remaining capacity and the rate of change.

### TECHNICAL FIELD

This invention relates to a fuel cell system including a fuel cell such as a direct oxidation fuel cell and a secondary battery, and more particularly, to hybrid control of the fuel cell system under which the operation state of the fuel cell is switched based on the remaining capacity of the secondary battery.

### BACKGROUND ART

Fuel cells are classified into polymer electrolyte fuel cells, phosphoric acid fuel cells, alkaline fuel cells, molten carbonate fuel cells, solid oxide fuel cells, etc. according to the kind of the electrolyte used. Among them, polymer electrolyte fuel cells (PEFCs) are becoming commercially available as the power source for automobiles, home cogeneration systems, etc, because they operate at low temperatures and have high output densities.

Recently, the use of fuel cells as the power source for portable small electronic devices, such as notebook personal computers, cellular phones, and personal digital assistants (PDAs), has been examined. Fuel cells can generate power continuously if they get refueled. Thus, the use of fuel cells in place of secondary batteries, which need recharging, is expected to improve the convenience of portable small electronic devices. Also, PEFCs are advantageous as the power source for portable small electronic devices due to the low operating temperature as mentioned above. Fuel cells are also becoming commercially available as the power source in outdoor leisure activities such as camping.

Among PEFCs, direct oxidation fuel cells (DOFCs) use a fuel that is liquid at room temperature, and generate electrical energy by directly oxidizing the fuel without reforming it into hydrogen. Hence, direct oxidation fuel cells do not require a reformer and can be easily miniaturized. Also, among direct oxidation fuel cells, direct methanol fuel cells (DMFCs), which use methanol as the fuel, are superior in energy efficiency and output power to other direct oxidation fuel cells. They are thus regarded as the most promising power source for portable small electronic devices.

The reactions of DMFCs at the anode and the cathode are represented by the following reaction formulae (11) and (12), respectively. Oxygen introduced into the cathode is usually taken from the air.

Anode: CH₃OH+H₂O→CO₂+6H⁺+6e⁻ (11)

Cathode: 3/2O₂+6H⁺+6e⁻→3H₂O (12)

A polymer electrolyte fuel cell such as a DMFC is usually produced by stacking a plurality of cells. Each cell includes a polymer electrolyte membrane and an anode and a cathode disposed so as to sandwich the polymer electrolyte membrane. Each of the anode and the cathode includes a catalyst layer and a diffusion layer, and for example, the anode of a DMFC is supplied with methanol as the fuel while the cathode is supplied with air as the oxidant.

An anode-side separator is disposed so as to come into contact with the anode diffusion layer, and a fuel flow channel for supplying the fuel to the anode is produced, for example, by forming a serpentine groove in the face of the anode-side separator in contact with the anode. Likewise, a cathode-side separator is disposed so as to come into contact with the cathode diffusion layer, and an air flow channel for supplying air to the cathode is produced, for example, by forming a serpentine groove in the face of the cathode-side separator in contact with the cathode.

Direct oxidation fuel cells such as DMFCs have a technical problem to be solved. That is, it is necessary to prevent the fuel (e.g., methanol) supplied to the anode from permeating through the polymer electrolyte membrane, reaching the cathode, and being oxidized. This phenomenon is called methanol crossover (MCO), and is a cause of a decrease in fuel utilization efficiency. Further, the oxidation reaction of the fuel at the cathode conflicts with the reduction reaction of the oxidant (oxygen) which normally occurs at the cathode, thereby lowering the cathode potential. Thus, MCO is a cause of a decrease in the voltage generated and the power generation efficiency.

Fuel cells need to be supplied with reactants from outside. Therefore, in applications in which the load varies sharply, it is common to combine a fuel cell with a power storage device such as a secondary battery or a capacitor to form a hybrid system. In particular, secondary batteries with high energy density, such as nickel cadmium secondary batteries, nickel metal hydride secondary batteries, and lithium ion secondary batteries, are promising as the power storage devices. Lithium ion secondary batteries in particular are the most promising power storage devices for fuel cell systems for portable devices, since they have the highest energy density and high long-term storage characteristics. However, in the case of such secondary batteries, it is usually desirable to charge and discharge them while keeping their remaining capacity in a suitable range, and if the remaining capacity is outside the suitable range, they tend to deteriorate significantly due to overcharge or overdischarge.

PTL 1 proposes detecting the capacity of a secondary battery, setting an instruction value for the output of a fuel cell based on the detected capacity, and operating the fuel cell based on the set instruction value. In this proposal, the output, start-up and shut-down of the fuel cell are instructed based on the capacity of the secondary battery. However, frequently repeating the start-up and shut-down of the fuel cell or changing the output is not necessarily a good approach in consideration of the power generation efficiency of the fuel cell. The power generation efficiency lowers significantly due to output variation particularly in direct oxidation fuel cells in which fuel crossover tends to occur. This is because the amount of fuel crossover changes due to excess and deficiency in a comparison between the current generated by the fuel cell and the amount of fuel supplied.

It is generally known that as the fuel stoichiometric ratio increases, the amount of fuel crossover increases and the fuel utilization efficiency decreases, thereby resulting in a decrease in power generation efficiency. The more excessive the amount of fuel supply is, compared with the necessary amount, the higher the fuel concentration is at the interface between the anode and the polymer electrolyte membrane. Thus, the concentration gradient inside the electrolyte membrane increases, and the diffusion speed of fuel inside the electrolyte membrane increases. The fuel stoichiometric ratio as used herein refers to a stoichiometric ratio in which, for example, the denominator is the amount of fuel that corresponds to the current generated and is calculated from the formula (11) and the numerator is the amount of fuel actually supplied.

However, if the fuel stoichiometric ratio is made very small, the fuel concentration inside the electrode of the fuel cell lowers significantly, and the voltage generated by the fuel cell lowers due to concentration overvoltage, thereby resulting in decreased output. Therefore, to obtain high power generation efficiency, it is necessary to select a suitable fuel stoichiometric ratio.

That is, to change the output of the fuel cell, first, it is necessary to change the current generated by the fuel cell. Then, it is necessary to multiply the changed current by a set fuel stoichiometric ratio to determine a set value of the amount of fuel supply, and change the amount of fuel supply to the set value. In this case, although the current value and the amount of fuel supply can be changed instantaneously, the fuel concentration inside the electrode actually changes after a time lag. For example, in the case of decreasing the output of the fuel cell, even when the current value and the amount of fuel supply have been decreased, the fuel remains in the flow channel formed in the anode-side separator or in the anode diffusion layer. Thus, the fuel becomes excessive compared with the amount of fuel consumed, and the fuel concentration increases at the interface between the anode and the electrolyte membrane. As a result, the amount of fuel crossover increases. Conversely, in the case of increasing the output, in order to prevent the concentration overvoltage from increasing due to fuel shortage, it is necessary to increase the amount of fuel supply in advance and then increase the current value. During the time lag, the fuel is excessively supplied to the anode, and thus the amount of fuel crossover increases.

To prevent the power generation efficiency from lowering in such a transient state of output change, PTL 2 proposes limiting the output control of a fuel cell to a plurality of power generation modes. Specifically, based on the remaining capacity of a secondary battery, the power generation modes are switched to reduce the frequency of switching the output of the fuel cell. This is expected to extend the life of the secondary battery while keeping the power generation efficiency of the fuel cell high.

### CITATION LIST

### Patent Literatures

PTL 1: Japanese Laid-Open Patent Publication No. 2002-34171
PTL 2: Japanese Laid-Open Patent Publication No. 2005-38791

### SUMMARY OF INVENTION

### Technical Problem

However, the proposal of PTL 2 does not always extend the life of the secondary battery. The reason for this is described below, taking a fuel cell system for use in outdoor leisure activities as an example.

In the case of using a fuel cell system as an auxiliary power source for a camping car, electrical devices such as a refrigerator, lighting, and a ventilator are constantly used, and the total power consumed thereby is less than 100 W. Also, devices consuming high power of 150 to 800 W such as a microwave oven, a coffee maker, and a satellite television system are used, although not frequently.

When used in such a manner, for example, the fuel cell system supplies power to the low power consumption devices with the output of the fuel cell set to 100 W, and supplies power to the high power consumption devices from a high output secondary battery included in the system. The high power consumption devices are used for several minutes to not longer than approximately 1 hour. Therefore, to make the system small and light-weight to improve the portability of the portable fuel cell system, it is necessary to make the capacity of the secondary battery minimum.

However, according to the proposal of PTL 2, when the remaining capacity of the secondary battery decreases sharply due to the use of the high power consumption devices, it is difficult to switch the power generation mode appropriately. This is because the power generation mode of the fuel cell cannot be changed until the remaining capacity of the secondary battery becomes less than a predetermined threshold value. As a result, when the high power consumption devices are connected, the remaining capacity of the secondary battery decreases significantly, or the secondary battery is charged frequently to compensate for a decrease of the remaining capacity, which heightens the frequency of the charge/discharge and promotes the deterioration of the secondary battery.

It is therefore an object of the invention to provide a fuel cell system capable of heightening the power generation efficiency of a fuel cell and extending the life of a secondary battery.

### Solution to Problem

The invention proposes determining not only the remaining capacity but also the rate of change of the remaining capacity and switching the power generation modes of a fuel cell based on the remaining capacity and the rate of change of the remaining capacity.

That is, one aspect of the invention relates to a method for controlling a fuel cell system including a fuel cell and a secondary battery for storing output power of the fuel cell. The method includes the steps of: detecting a remaining capacity of the secondary battery; determining a rate of change of the remaining capacity, where the rate of change is defined as positive when it increases and negative when it decreases; and changing an operation state of the fuel cell based on the remaining capacity and the rate of change.

Another aspect of the invention relates to a fuel cell system including: a fuel cell; a secondary battery for storing output power of the fuel cell; a remaining capacity detector for detecting a remaining capacity of the secondary battery; and a controller for determining a rate of change of the remaining capacity, where the rate of change is defined as positive when it increases and negative when it decreases, and changing an operation state of the fuel cell based on the remaining capacity and the rate of change.

### Advantageous Effects of Invention

The invention can provide a fuel cell system having high energy conversion efficiency and long life.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF DRAWINGS

FIG. 1 is an enlarged sectional view of a main part of a fuel cell included in a direct oxidation fuel cell system according to one embodiment of the invention;

FIG. 2 is a block diagram schematically showing the structure of the direct oxidation fuel cell;

FIG. 3 is a graph showing the relationship between the current and voltage of a direct oxidation fuel cell and the relationship between the current and output thereof;

FIG. 4a is a graph showing the relationship between the rate of change of the remaining capacity and the threshold values serving as the reference values for changing the power generation modes in a conventional direct oxidation fuel cell system;

FIG. 4b is a graph showing the relationship between the rate of change of the remaining capacity and the threshold values serving as the reference values for changing the power generation modes in a direct oxidation fuel cell system according to one embodiment of the invention;

FIG. 5 is a chart showing the procedure for switching the power generation modes;

FIG. 6 is a graph showing the relationship between time and power consumed by a load in a simulation of actual application load pattern;

FIG. 7a is a graph showing the changes of the remaining capacities of secondary batteries when fuel cell systems with an initial remaining capacity of 40% are operated in a load pattern of Pattern A;

FIG. 7b is a graph showing the changes of the remaining capacities of secondary batteries when fuel cell systems with an initial remaining capacity of 70% are operated in a load pattern of Pattern A;

FIG. 8a is a graph showing the changes of the remaining capacities of secondary batteries when fuel cell systems with an initial remaining capacity of 40% are operated in a load pattern of Pattern B; and

FIG. 8b is a graph showing the changes of the remaining capacities of secondary batteries when fuel cell systems with an initial remaining capacity of 70% are operated in a load pattern of Pattern B.

### DESCRIPTION OF EMBODIMENTS

One aspect of the invention relates to a method for controlling a fuel cell system including a fuel cell and a secondary battery for storing output power of the fuel cell. This control method includes the steps of: (i) detecting a remaining capacity of the secondary battery; (ii) determining a rate of change of the remaining capacity, where the rate of change is defined as positive when it increases and negative when it decreases; and (iii) changing an operation state of the fuel cell based on the remaining capacity and the rate of change.

The fuel cell system suitable for this control method includes, for example, a fuel cell; a secondary battery for storing output power of the fuel cell; a remaining capacity detector for detecting a remaining capacity of the secondary battery; and a controller for determining a rate of change of the remaining capacity, where the rate of change is defined as positive when it increases and negative when it decreases, and changing an operation state of the fuel cell based on the remaining capacity and the rate of change.

The step of changing the operation state is, for example, a step of switching the operation state between a plurality of power generation modes based on the remaining capacity and the rate of change.

In such a control method and a system, for example, the power generation modes are switched based on a result of comparison between the remaining capacity and at least one reference value (hereinafter “capacity threshold value”), and control modes each having the at least one reference value are switched based on a result of comparison between the rate of change and at least one predetermined value (hereinafter “threshold value of rate of change”).

As used herein, the power generation modes indicate the amounts of power generated by the fuel cell, and each power generation mode corresponds to an amount of power generation or a predetermined range of power generation amount. The control modes are control patterns for changing the power generation modes of the fuel cell according to the remaining capacity (x) of the secondary battery. Each control mode has a characteristic relation Y=f(x).

The amount of power generation is synonymous with the output power (W).

That is, the operation of the fuel cell is controlled by a plurality of control modes each having at least one capacity threshold value. The control modes are switched based on the rate of change of the remaining capacity of the secondary battery. Since the rate of change of the remaining capacity of the secondary battery reflects the power consumed by the load, switching the control modes based on the rate of change of the remaining capacity makes it possible to select a control mode suitable for the power consumption.

In the above case, the controller of the fuel cell system switches the power generation modes based on a result of comparison between the remaining capacity and at least one reference value (capacity threshold value), and switches the control modes each having the at least one reference value based on a result of comparison between the rate of change and at least one predetermined value (threshold value of rate of change).

The above control method can provide particularly high energy conversion efficiency when using a direct oxidation fuel cell as the fuel cell. It is also effective in providing long life when using a lithium ion secondary battery as the secondary battery. That is, the control method is most suitable for a fuel cell system including a direct oxidation fuel cell (in particular, a direct methanol fuel cell) and a lithium ion secondary battery.

However, the kind of the fuel cell and the secondary battery is not particularly limited, and any fuel cell and any secondary battery may be used as long as high energy conversion efficiency and long life can be obtained. For example, in the case of using a fuel cell in which fuel crossover occurs, the energy conversion efficiency can be improved.

In the above control method and system, for example, the remaining capacity is divided by N capacity threshold value(s) into (N+1) ranges where N is an integer of 1 or more, and each of (N+1) power generation modes is set for each of the (N+1) ranges of the remaining capacity. It is preferable to set the power generation modes for the respective ranges such that the amount of power generated by the fuel cell increases as the remaining capacity of the secondary battery decreases.

For example, when N=2, each of the control modes has two capacity threshold values. In this case, the range of the remaining capacity of the secondary battery is divided into three ranges: a high capacity range, a middle capacity range, and a low capacity range. The power generation mode of the fuel cell is determined based on which range the remaining capacity of the secondary battery is included in. For example, when the remaining capacity of the secondary battery is within the low capacity range, the fuel cell is operated in the power generation mode for generating the largest power assigned to the low capacity range. N is an integer of 1 or more and, for example, a numerical value such as 1, 2, 3, or 4 can be selected.

Also, in the above control method and system, for example, the rate of change of the remaining capacity is divided by M threshold value(s) of the rate of change into (M+1) ranges where M is an integer of 1 or more, and each of (M+1) control modes is set for each of the (M+1) ranges of the rate of change of the remaining capacity. It is preferable to set the control modes for the respective ranges such that the respective (N+1) capacity threshold values of the control modes decrease as the rate of change of the remaining capacity increases. By setting in this manner, the fuel cell is more likely to be operated in a power generation mode for generating a larger amount of power as the rate of change decreases, i.e., as the absolute value of the positive rate of change decreases or as the absolute value of the negative rate of change increases.

For example, when M=2, that is, when there are two threshold values of rate of change, the range of the rate of change is divided into three ranges: a high-rate range, a middle-rate range, and a low-rate range. Each of the three ranges is assigned a corresponding control mode. When N=2, each control mode has two capacity threshold values. The control mode assigned to the high-rate range has two capacity threshold values Chigh-1 and Chigh-2 (Chigh-1>Chigh-2). The control mode assigned to the middle-rate range has two capacity threshold values Cmiddle-1 and Cmiddle-2 (Cmiddle-1>Cmiddle-2). The control mode assigned to the low-rate range has two capacity threshold values Clow-1 and Clow-2 (Clow-1>Clow-2). These capacity threshold values are set such that Chigh-1<Cmiddle-1<Clow-1 and Chigh-2<Cmiddle-2<Clow-2. M is an integer of 1 or more and, for example, a numerical value such as 1, 2, 3, or 4 can be selected.

Using the relationship between the N capacity threshold values and the (N+1) power generation modes and the relationship between the M threshold values of the rate of change and the (M+1) control modes, the controller performs calculation based on the remaining capacity of the secondary battery and the rate of change thereof to select a suitable power generation mode. The relationship between the capacity threshold values and the power generation modes and the relationship between the threshold values of the rate of change and the control modes are stored, for example, in predetermined memory of the controller as the relationship between the range of the capacity, the range of the rate of change, and the power generation modes. In this case, the controller basically selects a power generation mode based on the following formula:

z=f(x,y)

where z is the power generation mode of the fuel cell, x is the remaining capacity of the secondary battery, and y is the rate of change of the remaining capacity of the secondary battery.

The step of changing the operation state may be a step of changing the control mode for controlling the operation state of the fuel cell continuously or in stages. In this case, the control mode can be changed such that the fuel cell is more likely to be operated in a power generation mode for generating a larger amount of power as the rate of change decreases, that is, as the absolute value of the positive rate of change decreases or as the absolute value of the negative rate of change increases. Also, the power generation mode may be changed continuously or in stages such that the amount of power generation increases as the remaining capacity decreases.

In this case, the amount (z) of power generated by the fuel cell is also a function of the remaining capacity (x) of the secondary battery and the rate of change (y) thereof, and has the relation z=f(x, y) where z is the power generation mode of the fuel cell, x is the remaining capacity of the secondary battery, and y is the rate of change of the remaining capacity of the secondary battery.

While the remaining capacity of the secondary battery can be detected by any method, it can be detected based on, for example, the voltage of the secondary battery. The voltage of the secondary battery can be detected by directly detecting the voltage between the terminals of the secondary battery, or can be detected based on the terminal voltage of a capacitor connected to the secondary battery in parallel.

The secondary battery can be composed of only one battery or a plurality of batteries. For example, it is possible to use a high capacity battery group comprising a plurality of secondary batteries connected in parallel, or a high voltage battery pack comprising such battery groups connected in series. In the case of using a battery group or battery pack comprising a plurality of secondary batteries connected in parallel or in series, the remaining capacity may be determined by measuring the respective secondary batteries and adding the measured values, or by measuring the terminal voltage of the battery group or battery pack.

Embodiments of the invention are hereinafter described with reference to drawings.

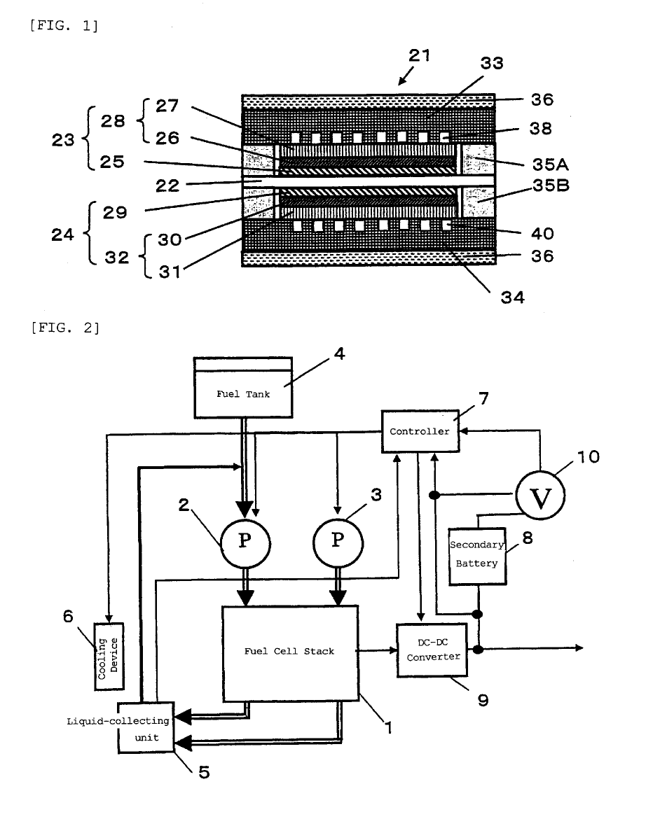

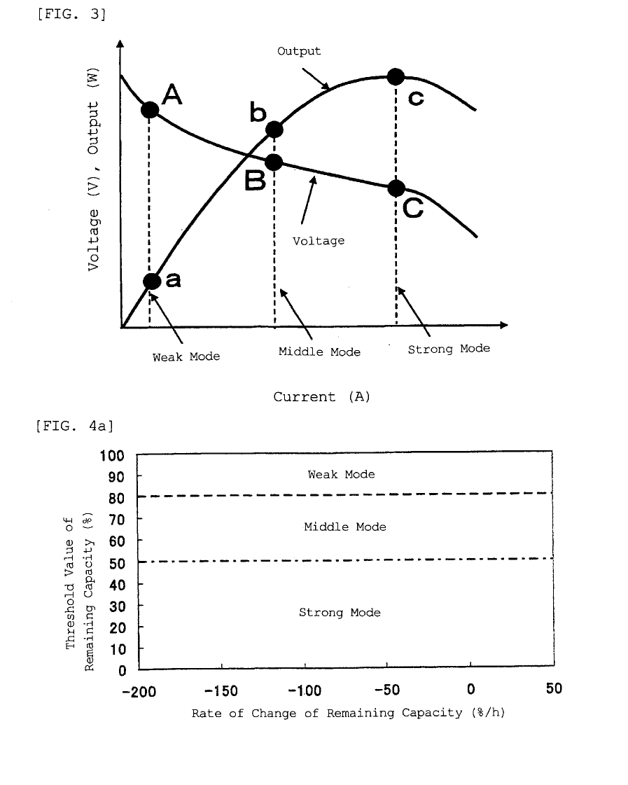

FIG. 1 is an enlarged sectional view of a main part of a fuel cell included in a fuel cell system according to one embodiment of the invention. FIG. 2 schematically shows the structure of the fuel cell system.

First, referring to FIG. 1, the structure of the fuel cell is described. Fuel cells typically include a cell stack comprising two or more cells electrically connected in series. The fuel cell of the fuel cell system according to this embodiment also includes two or more cells, but FIG. 2 shows the structure of one cell as an example.

A cell 21 illustrated therein is a direct methanol fuel cell which includes a polymer electrolyte membrane 22 and an anode 23 and a cathode 24 disposed so as to sandwich the polymer electrolyte membrane 22. The polymer electrolyte membrane 22 has hydrogen ion conductivity. The anode 23 is supplied with methanol as the fuel. The cathode 24 is supplied with air as the oxidant. A combination of the anode 23, the cathode 24, and the polymer electrolyte membrane 22 interposed therebetween is called an MEA (Membrane Electrode Assembly).

In the laminating direction of the anode 23, the polymer electrolyte membrane 22, and the cathode 24, an anode-side separator 33 is laminated on the anode 23, and an end plate 36A is disposed on the anode-side separator. Also, a cathode-side separator 34 is laminated on the cathode 24 (the lower side in the figure), and an end plate 36B is disposed on the cathode-side separator 34. When two or more cells 21 are stacked, the end plates 36A and 36B are not provided for each cell, and the end plates 36A and 36B are provided at both ends of the cell stack, respectively.

Between the anode-side separator 33 and the periphery of the polymer electrolyte membrane 22, a gasket 35A is disposed around the anode 23. Between the cathode-side separator 34 and the periphery of the polymer electrolyte membrane 22, a gasket 35B is disposed around the cathode 24. The gaskets 35A and 35B prevent the fuel and oxidant from leaking from the anode 23 and the cathode 24, respectively.

The two end plates 36A and 36B are clamped with bolts, springs, etc., not shown, so as to press the respective separators and the MEA, to form the cell 21. The interface between the MEA and the anode-side separator 33 and the cathode-side separator 34 has poor adhesion. Thus, by pressing the respective separators and the MEA as described above, the adhesion between the MEA and the respective separators can be increased. As a result, the contact resistance between the MEA and the respective separators can be reduced.

The anode 23 includes an anode catalyst layer 25 and an anode diffusion layer 28. The anode catalyst layer 25 is in contact with the polymer electrolyte membrane 22. The anode diffusion layer 28 includes an anode porous substrate 27 subjected to a water-repellent treatment, and an anode water-repellent layer 26 formed on a surface thereof and made of a highly water-repellent material. The anode water-repellent layer 26 and the anode porous substrate 27 are laminated in this order on the face of the anode catalyst layer 25 opposite to the face in contact with the polymer electrolyte membrane 22.

The cathode 24 includes a cathode catalyst layer 29 and a cathode diffusion layer 32. The cathode catalyst layer 29 is in contact with the face of the polymer electrolyte membrane 22 opposite to the face in contact with the anode catalyst layer 25. The cathode diffusion layer 32 includes a cathode porous substrate 31 subjected to a water-repellent treatment, and a cathode water-repellent layer 30 formed on a surface thereof and made of a highly water-repellent material. The cathode water-repellent layer 30 and the cathode porous substrate 31 are laminated in this order on the face of the cathode catalyst layer 29 opposite to the face in contact with the polymer electrolyte membrane 22.

A laminate comprising the polymer electrolyte membrane 22, the anode catalyst layer 25, and the cathode catalyst layer 29 is the power generation area of the fuel cell, which is called a CCM (Catalyst Coated Membrane). The MEA is a laminate of the CCM, the anode diffusion layer 28 and the cathode diffusion layer 32. The anode diffusion layer 28 and the cathode diffusion layer 32 have the functions of uniformly diffusing the fuel and oxidant supplied to the anode 23 and the cathode 24, respectively, as well as the function of smoothly removing the products, namely, water and carbon dioxide.

The face of the anode-side separator 33 in contact with the anode porous substrate 27 has a fuel flow channel 38 for supplying the fuel to the anode 23. The fuel flow channel 38 is formed, for example, in the above-mentioned contact face and comprises a recess or groove which is open toward the anode porous substrate 27.

The face of the cathode-side separator 34 in contact with the cathode porous substrate 31 has an air flow channel 40 for supplying the oxidant (air) to the cathode 24. The air flow channel 40 can also be formed, for example, in the above-mentioned contact face and comprises a recess or groove which is open toward the cathode porous substrate 31.

The fuel flow channel 38 of the anode-side separator 33 and the air flow channel 40 of the cathode-side separator 34 can be formed by, for example, by cutting a groove in a surface of the separator. The fuel flow channel 38 and the air flow channel 40 can also be formed when the separator itself is formed by a method such as injection molding or compression molding.

The anode catalyst layer 25 includes anode catalyst particles for promoting the reaction represented by the reaction formula (11) and a polymer electrolyte for providing ion conductivity between the anode catalyst layer 25 and the polymer electrolyte membrane 22. Examples of the polymer electrolyte contained in the anode catalyst layer 25 include a perfluorosulfonic acid/polytetrafluoroethylene copolymer (H⁺ type), sulfonated polyether sulfone (H⁺ type), and aminated polyether sulfone (OH⁻ type).

The anode catalyst particles can be supported on a support comprising conductive carbon particles such as carbon black. The anode catalyst particles can be formed of an alloy containing platinum (Pt) and ruthenium (Ru) or a mixture of Pt and Ru. In order to increase the active sites of the anode catalyst particles and heighten the reaction speed, it is preferable to make the size of the anode catalyst particles as small as possible for use. The mean particle size of the anode catalyst particles can be set to 1 to 20 nm.

The cathode catalyst layer 29 includes cathode catalyst particles for promoting the reaction represented by the reaction formula (12) and a polymer electrolyte for providing ion conductivity between the cathode catalyst layer 29 and the polymer electrolyte membrane 22. The polymer electrolyte contained in the cathode catalyst layer 29 can be any material mentioned as the polymer electrolyte contained in the anode catalyst layer 25.

The cathode catalyst particles may be used as they are, or may be supported on a support comprising conductive carbon particles such as carbon black. Examples of the cathode catalyst particles include Pt simple substance and Pt alloys. Examples of Pt alloys include alloys of Pt and transition metals such as cobalt and iron.

The material of the polymer electrolyte membrane 22 is not particularly limited if the polymer electrolyte membrane 22 has ion conductivity. As such materials, for example, various polymer electrolyte materials known in the art may be used. Most of the currently available polymer electrolyte membranes are hydrogen ion conductive electrolyte membranes.

Examples of the polymer electrolyte membrane 22 include fluoropolymer membranes. Examples of fluoropolymer membranes include polymer membranes including a perfluorosulfonic acid polymer such as a perfluorosulfonic acid/polytetrafluoroethylene copolymer (H⁺ type). An example of such membranes including a perfluorosulfonic acid polymer is a Nafion membrane (trade name: “Nafion®”, available from E.I. Dupont de Nemours and Company).

The polymer electrolyte membrane 22 preferably has the effect of reducing the crossover of the fuel (e.g., methanol) used in fuel cells. Examples of such polymer electrolyte membranes include the above-mentioned fluoropolymer membranes, membranes comprising a fluorine-atom-free hydrocarbon polymer such as sulfonated polyether ether sulfone (S-PEEK), and composite membranes comprising inorganic and organic materials.

Examples of porous substrates used as the anode porous substrate 27 and the cathode porous substrate 31 include carbon paper comprising carbon fibers, carbon cloth, carbon non-woven fabric (carbon felt), corrosion-resistant metal mesh, and metal foam.

Examples of highly water-repellent materials used to form the anode water-repellent layer 26 and the cathode water-repellent layer 30 include fluoropolymers and fluorinated graphite. An example of fluoropolymers is polytetrafluoroethylene (PTFE).

The anode-side separator 33 and the cathode-side separator 34 can be formed of, for example, a carbon material such as graphite. The separators have the function as partitions for blocking circulation of chemical substances between the cells, as well as the function to provide electronic conduction between the cells and connect the respective cells in series.

Examples of materials of the gaskets 35A and 35B include fluoropolymers such as PTFE and a tetrafluoroethylene-hexafluoropropylene copolymer (FEP), synthetic rubbers such as fluorocarbon rubber and ethylene-propylene-diene rubber (EPDM), and silicone elastomers. A gasket can be produced by providing a central part of a sheet made of PTFE or the like with an opening for receiving the anode or cathode.

The voltage generated by the direct oxidation fuel cell is 0.3 to 0.5 V per unit cell. When a plurality of cells are stacked and electrically connected in series, the output voltage of the fuel cell stack is the product of the output voltage per unit cell and the number of the cells stacked. Generally, a significant increase in the number of the stacked cells results in an increase in the number of components of the fuel cell stack, the number of assembly steps, and therefore production costs. Thus, the voltage generated by the fuel cell stack is boosted by a DC-DC converter 9 to be supplied to an electrical device or supplied to an inverter for generating alternating current.

Next, referring to FIG. 2, the structure of the fuel cell system of the invention is described.

The fuel cell system illustrated therein includes: a fuel cell stack 1; a fuel supply device 2 for supplying a fuel to the anode; an air supply device 3 for supplying air to the cathode; a fuel tank 4 for supplying the fuel to the fuel supply device; a liquid-collecting unit 5 for storing an effluent from the anode and the cathode; a cooling device 6 for cooling the fuel cell system 1; a controller 7 for controlling the operation state of the whole system; a secondary battery 8 for storing the output power of the fuel cell stack; the DC-DC converter 9; and a remaining capacity detector 10 for detecting the remaining capacity of the secondary battery. The fuel cell system may include an inverter (not shown) for outputting alternating-current power between the DC-DC converter 9 and the electrical device.

The input terminal of the DC-DC converter 9 is connected to the fuel cell stack 1, while the output terminal is connected to the electrical device which is not shown. The output terminal of the DC-DC converter 9 is also connected to the secondary battery 8 to store power that is output by the fuel cell stack 1 via the DC-DC converter 9 and that is not to be supplied to the electrical device. The power stored in the secondary battery 8 is supplied to the load device, when necessary.

The DC-DC converter 9 converts the output of the fuel cell stack 1 to a desired voltage according to the instruction of the controller 7. Specifically, the controller 7 controls the output of the fuel cell stack 1 via the DC-DC converter 9 such that the output is suitable for the charge/discharge of the secondary battery 8. The charge/discharge of the secondary battery is controlled by the controller 7 based on the power required by the electrical device or the remaining capacity of the secondary battery. The remaining capacity of the secondary battery changes every time charge/discharge is performed.

The remaining capacity of the secondary battery is detected by the remaining capacity detector 10. The controller 7 obtains the detected remaining capacity and the rate of change thereof, and switches the output of the fuel cell stack between a plurality of power generation modes based on these values. Specifically, based on the remaining capacity of the secondary battery and the rate of change thereof, the controller changes the output of the fuel supply device 2 and the air supply device 3, and controls the DC-DC converter 9 to change the output voltage. In this manner, the power generation mode of the fuel cell stack is changed.

The controller 7 can be composed of an arithmetic unit, a storage device (memory), software and various logic circuits for control of the invention, etc. The arithmetic unit can be a central processing unit (CPU), microprocessor (MPU), etc. Typically, a personal computer (PC) or a micro computer can be utilized as the controller.

Various feed pumps can be used as the fuel supply device 2 and the air supply device 3. Examples include micro pumps utilizing a piezoelectric element and a diaphragm.

The fuel tank 4 stores methanol or an aqueous methanol solution as the fuel. The fuel stored in the fuel tank 4 is transported to each anode 23 of the fuel cell stack 1 by the fuel supply device 2. The fuel to be transported to the fuel cell stack 1 may be transported directly to the fuel cell stack 1 in some cases; however, it is usually mixed with a liquid collected and supplied by the liquid-collecting unit 5, and the diluted fuel is transported to the fuel cell stack 1. The reason why methanol is diluted is that high concentration methanol supplied to the anode 23 results in significant methanol crossover (MCO).

The fuel stoichiometry Fₛₜₒ is a coefficient obtained by dividing the amount of fuel supplied to the anode by the amount of fuel converted from the value of current generated, i.e., the amount of fuel actually used to generate power, and it can be determined from the following formula (1):

Fₛₜₒ=(I1+I2)/I1 (1)

where I1 is the current generated and I2 is the value of current converted from the sum of the amount of unconsumed fuel and the amount of crossover methanol fuel.

The controller 7 determines the amount of fuel supply (the value of fuel converted from I1+I2) based on information of the measured value of current generated by the fuel cell stack and the set fuel stoichiometry Fₛₜₒ. Further, in consideration of the concentration of the fuel supplied to the anode 23, the controller sends a control signal to the fuel supply device 2 such that the fuel supply device 2 can supply the determined amount of fuel.

Also, the fuel utilization rate Fᵤₜᵢ can be determined from the following formula (2):

Fᵤₜᵢ=I1/(I1+I_{MCO}) (2)

where I_{MCO} is the current value converted from the amount of crossover methanol fuel corresponding to MCO.

Of the fuel transported to the fuel cell stack 1, surplus fuel corresponding to I2 is supplied again to the fuel cell stack 1 via the liquid-collecting unit 5 without being consumed in the fuel cell stack 1. However, if the fuel stoichiometry Fₛₜₒ is set to a sufficiently small value, the amount of surplus fuel corresponding to I2 is very small, and the amount of fuel contained in the liquid discharged from the fuel cell stack 1 is very small. In this case, the fuel supplied from the fuel tank 4 and the water that is supplied from the liquid-collecting unit 5 and contains a very small amount of fuel are mixed in a mixing tank (not shown). Such mixing may be done by a mixing portion provided inside the fuel supply device 2.

The air serving as the oxidant is transported to each cathode 24 of the fuel cell stack 1 by the air supply device 3 via an air pipe. Water is produced at the cathode 24. Part of the product water is collected into the liquid-collecting unit 5, where it is stored as liquid water to be used for dilution of fuel. Surplus water is separated as steam by the gas-liquid separation film installed in the liquid-collecting unit 5 together with the air supplied to the cathode 24, and is discharged to outside from the liquid-collecting unit 5. Carbon dioxide produced at the anode 23 as a result of power generation is also separated by the gas-liquid separation film and discharged to outside from the liquid-collecting unit 5.

The liquid-collecting unit 5 is composed of, for example, a container having an upper opening and a gas-liquid separation film (not shown) closing the opening. The gas-liquid separation film separates liquids, namely, water and unused fuel, from gases, namely, air, steam, and carbon dioxide. The liquid-collecting unit 5 preferably has a sensor for detecting the amount of water stored.

Information on the amount of liquid is sent to the controller 7. When excessive water is stored due to continuous operation for a long time, the controller 7 increases the output of the air supply device 3 to supply air into the liquid-collecting unit 5, thereby increasing the amount of water dissipated as steam. On the other hand, when the water in the liquid-collecting unit 5 is insufficient, the cooling device 6 is fully operated to lower the temperature of the fuel cell stack 1 or the temperature of the liquid-collecting unit 5, thereby decreasing the amount of steam dissipated from the liquid-collecting unit 5. In this manner, the liquid-collecting unit 5 cooperates with the controller 7, the air supply device 3, and the cooling device 6 to function as a buffer for controlling the amount of water in the system.

The cooling device 6 comprises, for example, an air-blowing device. The air-blowing device may be a fan such as a sirocco fan, a turbo fan, an axial fan, or a cross-flow fan, a blower such as a centrifugal blower, an axial blower, or a positive displacement blower, or a fan motor.

The secondary battery 8 may be a nickel-metal hydride storage battery, a nickel-cadmium storage battery, a lithium ion secondary battery, etc. Among them, the lithium ion secondary battery is particularly suitable for the fuel cell system of the invention, because it has high output and high energy density. A battery group or battery pack comprising a plurality of secondary batteries connected in parallel or in series may also be used. Since the common D/C output voltage is 12 V or 24 V, for example, a battery pack including 4 or 7 cells connected in series is used in the case of lithium ion batteries. Also, a plurality of cells are connected in parallel, depending on the necessary capacity.

The remaining capacity detector 10 includes, for example, a voltmeter for measuring the voltage of the secondary battery, and stores the relationship between the voltage of the secondary battery and the remaining capacity. The remaining capacity detector 10 detects the voltage of the secondary battery and determines the remaining capacity corresponding to the detected voltage. The remaining capacity detector 10 may cooperate with the controller 7 to determine the remaining capacity. The remaining capacity detected by the battery remaining capacity detector 10 is sent to the controller 7. The controller 7 calculates the rate of change of the remaining capacity from the information on the remaining capacity, and controls the output of the fuel cell stack 1 based on the information. As the voltage of the secondary battery, an open circuit voltage may be measured, or a closed circuit voltage with a relatively small load connected may be measured. Also, the voltage of each cell may be measured, or the voltage of the whole battery pack may be measured. The remaining capacity detector 10 may also include an ampere-hour meter for constantly measuring the charge/discharge current of the secondary battery and integrating the measured values.

When the remaining capacity of the secondary battery 8 and the rate of change thereof are determined from a small number of voltage measurement results, an error may occur between the determined values and the actual remaining capacity and the rate of change thereof. For example, if the load changes rapidly, the battery voltage changes sharply, thereby resulting in a large error. It is therefore preferable to determine the hourly average of a plurality of measurement results by calculation.

It is also possible to connect a capacitor in parallel with the secondary battery and measure the voltage between the terminals of the capacitor, in order to determine the average voltage of the secondary battery. That is, the so-called flying capacitor method may be employed. In this case, the voltage of the capacitor is the average voltage in a certain period of time without being affected by sharp voltage variation in a short period of time. Thus, calculation for averaging the voltage becomes unnecessary, and complicated calculation can be avoided. Also, the voltage of the secondary battery can be measured accurately without electrical grounding.

The rate of change of the remaining capacity of the secondary battery is defined as positive when the remaining capacity increases. While the unit for the rate of change is not particularly limited, it can be defined, for example, as the amount of change (%) of SOC per hour. The term SOC refers to a parameter that indicates the state of charge of a secondary battery; when the battery is fully charged and has a capacity corresponding to the nominal capacity, the SOC is 100%, and when it is fully discharged and has a voltage corresponding to the end-of-discharge voltage, the SOC is 0%.

When the power consumed by the electrical device becomes larger than the power obtained by subtracting the power consumed by auxiliary devices (e.g., the fuel supply device 2 and the air supply device 3) for operating the fuel cell stack 1 from the output of the fuel cell stack 1, the secondary battery 8 is discharged. Thus, the rate of change of the remaining capacity becomes a negative value. Conversely, when the secondary battery 8 is charged, the rate of change of the remaining capacity becomes a positive value.

Next, the method for switching the power generation modes of the fuel cell system is described.

Generally, the relationship between the current and voltage of a fuel cell and the relationship between the current and the output power describe curves as shown in FIG. 3. Thus, by determining the current value or voltage value, the output power can be controlled. For example, the controller 7 gives the DC-DC converter 9 an instruction of a target input voltage to control the output power of the fuel cell such that the output power reaches the target value.

Basically, the fuel cell stack 1 can be operated at any point on the current voltage curve and the current output curve in FIG. 3. However, in the invention, a small limited number of power generation modes are set to prevent a decrease in fuel utilization rate and complicated control due to frequent output variation. FIG. 3 shows three modes of strong mode (point C, c), middle mode (point B, b), and weak mode (point A, a) as examples of the power generation modes. The strong mode is a point at which the output on the current output curve becomes largest. The weak mode is a point at which the power consumed by the fuel supply device 2, the air supply device 3, the cooling device 6, the controller 7, etc. necessary for operating the fuel cell is almost equal to the output of the fuel cell stack 1. The middle mode is a mid point therebetween.

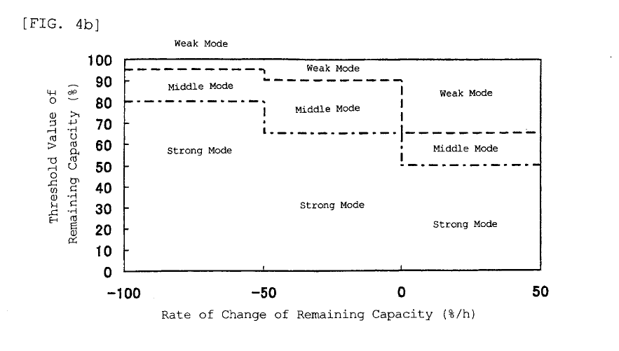

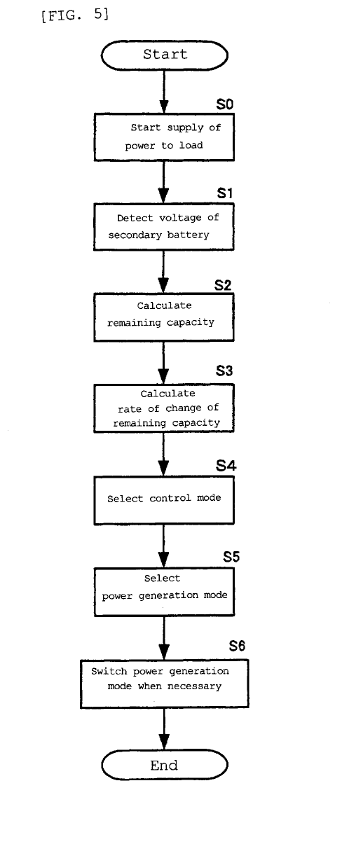

Such three power generation modes are described below as examples with reference to FIG. 4a and FIG. 4b.

First, FIG. 4a shows the capacity threshold values for conventional switching of power generation modes.

When the number of the power generation modes is three, there are two capacity threshold values. That is, when the remaining capacity is equal to or more than the broken line in the figure, the weak mode is used for operation, and when it is equal to or less than the dot-dashed line in the figure, the strong mode is used for operation. When it is between them, the middle mode is used for operation.

In order to reduce the frequency of switching between the respective modes to increase the power generation efficiency of the fuel cell, it is preferable to widen the interval between the broken line and the dot-dashed line, i.e., the range of the remaining capacity for the operation using the middle mode. For example, the interval between the broken line and the dot-dashed line is preferably in the range of 20 to 40% when the SOC corresponding to the whole battery capacity is defined as 100%. In particular, when the secondary battery is a lithium ion battery, the remaining capacity at the midpoint between the broken line and the dot-dashed line is preferably 40 to 60%, since the performance degradation is smallest when the remaining capacity is in a middle range.

Next, FIG. 4b shows the capacity threshold values for switching the power generation modes according to the invention. Therein, the rate of change of the remaining capacity is divided into three ranges by two threshold values of the rate of change, and a control mode having two capacity threshold values is set for each of the ranges. It should be noted that the number of the ranges for the rate of change of the remaining capacity does not need to be three, and may be any number of 2 or more.

First, in a low-rate range in which the rate of change of the remaining capacity is smallest (when the amount of change of SOC per hour is in the range of −100% to −50%), a large amount of power is consumed by the load, and the secondary battery is discharged at a large current, so that the remaining capacity of the secondary battery decreases rapidly. If such a state is continued, the secondary battery will eventually have no remaining capacity, or, in the case of a battery pack, part of the cells may become overdischarged. Also, when the secondary battery is provided with a protection mechanism that stops discharge when the remaining capacity becomes lower than a certain threshold value in order to prevent part of the cells from becoming overdischarged, the stop of the discharge makes the electrical device unusable.

Therefore, before the remaining capacity of the secondary battery decreases significantly, it is necessary to change the output of the fuel cell stack 1 to the strong mode to lessen the decrease of the remaining capacity. However, if the power generation modes are switched as shown in FIG. 4a, the timing of changing to the strong mode may be late. As a result, the discharge of the secondary battery may be stopped early, or the secondary battery may be charged after being discharged to a deep discharge depth, which promotes the deterioration of the secondary battery.

On the other hand, in the case of switching the control modes based on the rate of change of the remaining capacity, in the low-rate range (the range of −100% to −50%) in which the rate of change of the remaining capacity is smallest, two capacity threshold values can be set high and the range between the threshold values can be set small. As a result, regardless of the state of the remaining capacity of the secondary battery, when the secondary battery is discharged at a large current, it is possible to promptly change to the strong mode to delay the decrease of the remaining capacity of the secondary battery.

In a high-rate range (the range of 0 to 50%) in which the rate of change of the remaining capacity is largest, the power consumed by the load is small, and the secondary battery is hardly discharged, or is charged. In this case, the remaining capacity of the secondary battery hardly changes, or increases. In such a state, if the fuel cell stack generates an unnecessarily large output, the secondary battery is charged rapidly. Generally, the deterioration of secondary batteries due to charge/discharge cycles increases as the charge current increases. Also, in the case of a battery pack, if the battery pack having a high remaining capacity is further charged, part of the cells become overcharged and the battery performance deteriorates. Therefore, in the range in which the rate of change of the remaining capacity is largest, it is preferable to promptly change the fuel cell to the weak mode to decrease the current for charging the secondary battery, or to cause the secondary battery to discharge slightly, in order to keep the remaining capacity of the secondary battery medium. To do this, in the high-rate range in which the rate of change of the remaining capacity is largest, it is desirable to set the two capacity threshold values medium.

In a middle-rate range (the range of −50% to 0%) in which the rate of change of the remaining capacity is medium, the power consumed by the load is slightly larger than the output of the fuel cell stack 1, and the secondary battery is discharged mildly. The change of the remaining capacity is not so large, and a medium remaining capacity can be easily maintained. In such a state, the capacity threshold values can be set to mid points between the smallest range and the largest range for the rate of change of the remaining capacity. That is, it is preferable to set the two capacity threshold values medium, with the range between the threshold values being medium.

In the case of setting the three control modes as described above, it is preferable to set the two threshold values of the rate of change, for example, as follows, in which the threshold values are expressed as the amount (%) of change of SOC per hour.

The smaller threshold value of the rate of change: −1000 to 0%

The larger threshold value of the rate of change: −100 to 50%

Also, the two threshold values of the rate of change are preferably 20 to 100% apart from each other.

In this case, the two capacity threshold values Chigh-1 and Chigh-2 (Chigh-1>Chigh-2) of the control mode assigned to the high-rate range in which the rate of change is largest are preferably in the range of 80 to 100% and the range of 70 to 90%, respectively. The two capacity threshold values Cmiddle-1 and Cmiddle-2 (Cmiddle-1>Cmiddle-2) of the control mode assigned to the middle-rate range are preferably in the range of 65 to 90% and the range of 50 to 85%, respectively. The two capacity threshold values Clow-1 and Clow-2 (Clow-1>Clow-2) of the control mode assigned to the low-rate range are preferably in the range of 50 to 80% and the range of 40 to 70%, respectively. Also, preferably, Chigh-1<Cmiddle-1<Clow-1, and Chigh-2<Cmiddle-2<Clow-2.

In FIGS. 4a and 4b, the two capacity threshold values are set for each of the three control modes, but the capacity threshold values may be provided with hysteresis. That is, the capacity threshold value for changing from the weak mode to the middle mode or from the middle mode to the strong mode may be made smaller than the capacity threshold value for changing from the strong mode to the middle mode or from the middle mode to the weak mode. Herein, the threshold value for increasing the output from that in the current power generation mode is referred to as a lower threshold value, and the threshold value for decreasing the output from that in the current power generation mode is referred to as an upper threshold value. By setting such hysteresis, it is possible to prevent the remaining capacity from varying around the threshold value and falling into a so-called hunting state. If it falls into a hunting state, the power generation mode may be switched frequently. For example, it is preferable to set the lower threshold value to a value smaller than the upper threshold value by approximately 1 to 10% in terms of preventing the hunting phenomenon.

The power generation modes are selected, for example, in the following procedure. FIG. 5 shows a flow chart.

First, the fuel cell system is started up to start the supply of power to the load (S0), and then the remaining capacity detector detects the voltage of the secondary battery (S1) to calculate the remaining capacity (S2). The remaining capacity detector includes, for example, a voltmeter and memory for storing the relationship between the voltage and the remaining capacity of the secondary battery obtained in advance and storing the detected voltage values. In calculating the remaining capacity from the above-mentioned relationship and the detected voltage value, the arithmetic unit of the controller can be utilized. The voltage is detected every predetermined period of time. The calculation for calculating the remaining capacity from the detected voltage value may be performed every voltage detection or once in a plurality of voltage detections.

Next, the controller calculates the rate of change of the remaining capacity, for example, from the remaining capacity at the L^{th} calculation and the remaining capacity at the L+1^{th} calculation (S3). It should be noted that the rate of change of the remaining capacity is defined as positive when it increases and negative when it decreases.

Upon calculation of the rate of change of the remaining capacity, the controller determines which range of the (M+1) ranges divided by M threshold values of the rate of change the calculated rate of change is included in, and selects a control mode based on the determination result (S4).

Upon selection of the control mode, the controller determines which range of the (N+1) capacity ranges divided by N capacity threshold values of the selected control mode the remaining capacity at the L^{th} or L+1^{th} calculation is included in, and selects a power generation mode based on the determination result (S5).

Upon selection of the power generation mode, the controller determines whether the fuel cell is generating power in the selected power generation mode, and, if necessary, switches the power generation mode (S6).

The invention can provide a fuel cell system that is small and light-weight due to minimum output of a fuel cell and minimum capacity of a secondary battery, but enables use of various devices that consume different amounts of power and allows the output of the fuel cell to be controlled suitably according to the amount of power consumption to provide high energy conversion efficiency and long life.

The above embodiments have been described with reference to the cases where a DMFC using methanol as the fuel is used, but the fuel cell is not limited to a DMFC. However, the invention is particularly effective when applied to direct oxidation fuel cells using fuels that have high affinity for water and are liquid at room temperature. Examples of the fuels that are liquid at room temperature include hydrocarbon liquid fuels such as ethanol, dimethyl ether, formic acid, and ethylene glycol as well as methanol.

The invention is hereinafter described specifically by way of Examples and Comparative Examples, but the invention is not to be construed as being limited to the following Examples.

### Example 1

A supported anode catalyst comprising anode catalyst particles supported on a conductive support was prepared. A platinum-ruthenium alloy (atomic ratio 1:1) (mean particle size: 5 nm) was used as the anode catalyst particles. Conductive carbon particles with a mean primary particle size of 30 nm were used as the support. The weight of the platinum-ruthenium alloy was set to 80% by weight of the total weight of the platinum-ruthenium alloy and the conductive carbon particles.

A supported cathode catalyst comprising cathode catalyst particles supported on a conductive support was prepared. Platinum (mean particle size: 3 nm) was used as the cathode catalyst particles. Conductive carbon particles with a mean primary particle size of 30 nm were used as the support. The weight of the platinum was set to 80% by weight of the total weight of the platinum and the conductive carbon particles.

A 50-μm thick fluoropolymer membrane (a film composed basically of a perfluorosulfonic acid/polytetrafluoroethylene copolymer (H⁺ type), trade name “Nafion® 112”, available from E.I. Du Pont de Nemours & Co. Inc.) was used as the polymer electrolyte membrane.

### (a) Preparation of CCM

### (i) Formation of Anode

10 g of the supported anode catalyst, 70 g of a liquid dispersion containing a perfluorosulfonic acid/polytetrafluoroethylene copolymer (H⁺ type) (trade name: “Nafion® 5 wt % solution”, available from E.I. Du Pont de Nemours & Co. Inc. of the United States), and a suitable amount of water were stirred and mixed with a stirring device. The resultant mixture was defoamed to prepare an ink for forming an anode catalyst layer.

The anode-catalyst-layer forming ink was sprayed onto a surface of the polymer electrolyte membrane by a spray method using an air brush, to form a 10-cm square anode catalyst layer. The dimensions of the anode catalyst layer were adjusted by masking. When the anode-catalyst-layer forming ink was sprayed, the polymer electrolyte membrane was fixed to a metal plate by reducing the pressure to adsorb the polymer electrolyte membrane onto the metal plate, and at this time, the surface temperature of the metal plate was adjusted by a heater. The anode-catalyst-layer forming ink was gradually dried during application. The thickness of the anode catalyst layer was 61 μm, and the amount of the Pt—Ru per unit area was 3 mg/cm².

### (ii) Formation of Cathode

10 g of the supported cathode catalyst, 100 g of a liquid dispersion containing a perfluorosulfonic acid/polytetrafluoroethylene copolymer (H⁺ type) (trade name “Nafion® 5 wt % solution” mentioned above), and a suitable amount of water were stirred and mixed with a stirring device. The resultant mixture was defoamed to prepare an ink for forming a cathode catalyst layer.

The cathode-catalyst-layer forming ink was applied onto the face of the polymer electrolyte membrane opposite to the face with the anode catalyst layer by the same method as that used to form the anode catalyst layer. In this manner, a 10-cm square cathode catalyst layer was formed on the polymer electrolyte membrane. The amount of Pt contained in the cathode catalyst layer per unit area was 1 mg/cm².

The anode catalyst layer and the cathode catalyst layer were disposed such that their centers overlapped in the thickness direction of the polymer electrolyte membrane.

In this manner, a CCM was prepared.

### (b) Preparation of MEA

### (i) Preparation of Anode Porous Substrate

A carbon paper subjected to a water-repellent treatment (trade name “TGP-H-090”, approximately 300 μm in thickness, available from Toray Industries Inc.) was immersed in a diluted polytetrafluoroethylene (PTFE) dispersion (trade name “D-1”, available from Daikin Industries, Ltd.) for 1 minute. The carbon paper was then dried in a hot air dryer in which the temperature was set to 100° C. Subsequently, the dried carbon paper was baked at 270° C. in an electric furnace for 2 hours. In this manner, an anode porous substrate with a PTFE content of 10% by weight was produced.

### (ii) Preparation of Cathode Porous Substrate

A cathode porous substrate with a PTFE content of 10% by weight was produced in the same manner as the anode porous substrate except for the use of a carbon cloth (trade name “AvCarb™ 1071HCB”, available from Ballard Material Products Inc.) in place of the carbon paper subjected to a water-repellent treatment.

(iii) Preparation of Anode Water-Repellent Layer

An acetylene black powder and a PTFE dispersion (trade name “D-1” available from Daikin Industries, Ltd.) were stirred and mixed with a stirring device to prepare an ink for forming a water-repellent layer having a PTFE content of 10% by weight of the total solid content and an acetylene black content of 90% by weight of the total solid content. The water-repellent-layer forming ink was sprayed onto a surface of the anode porous substrate by a spray method using an air brush. The sprayed ink was then dried in a thermostat in which the temperature was set to 100° C. Subsequently, the anode porous substrate sprayed with the water-repellent-layer forming ink was baked at 270° C. in an electric furnace for 2 hours to remove the surfactant. In this manner, an anode water-repellent layer was formed on the anode porous substrate to produce an anode diffusion layer comprising the anode porous substrate and the anode water-repellent layer.

### (iv) Preparation of Cathode Water-Repellent Layer

A cathode water-repellent layer was formed on a surface of the cathode porous substrate in the same manner as the anode water-repellent layer, to produce a cathode diffusion layer comprising the cathode porous substrate and the cathode water-repellent layer.

Each of the anode diffusion layer and the cathode diffusion layer was formed into a 10-cm square using a punching die.

Subsequently, the anode diffusion layer and the CCM were laminated such that the anode water-repellent layer was in contact with the anode catalyst layer. Also, the cathode diffusion layer and the CCM were laminated such that the cathode water-repellent layer was in contact with the cathode catalyst layer.

The resultant laminate was pressed with a pressure of 5 MPa for 1 minute, using a hot press machine whose temperature was set to 125° C. In this manner, the anode catalyst layer and the anode diffusion layer were bonded, and the cathode catalyst layer and the cathode diffusion layer were bonded.

In the above manner, a membrane electrode assembly (MEA) comprising the anode, the polymer electrolyte membrane, and the cathode was produced.

### (c) Arrangement of Gaskets

A 0.25-mm thick sheet of ethylene propylene diene rubber (EPDM) was cut to a 12-cm square. Further, a central part of the sheet was cut off to form a 10-cm square opening. In this manner, two gaskets were prepared. The respective gaskets were attached to the MEA so that the anode was fitted into the opening of one of the gaskets while the cathode was fitted into the opening of the other gasket.

### (d) Preparation of Separator

A resin-impregnated graphite plate having a thickness of 2 mm and a 12-cm square shape was prepared as a material of a separator. One surface of the graphite plate was cut so that a fuel flow channel for supplying an aqueous methanol solution to the anode was formed on one side. One end of the separator was provided with an inlet of the fuel flow channel, while the other end was provided with an outlet.

The other surface of the graphite plate was provided with an air flow channel for supplying air to the cathode as the oxidant. One end of the separator was provided with an inlet of the air flow channel, while the other end was provided with an outlet. In this manner, separators for a fuel cell stack 1 were prepared.

The grooves of the fuel flow channel and the air flow channel had a width of 1 mm and a depth of 0.5 mm in cross-section. Also, the fuel flow channel and the air flow channel were of the serpentine type capable of uniformly supplying the fuel and air to the whole anode diffusion layer and the whole cathode diffusion layer.

### (e) Production of DMFC Stack

MEAs and separators thus produced were stacked so that the fuel flow channel of each separator was in contact with the anode diffusion layer while the air flow channel was in contact with the cathode diffusion layer, to form 20 cells. It should be noted that a pair of separators positioned at the outermost part was provided with only a fuel flow channel or an air flow channel on one face.

Both ends of the stack of 20 cells in the stacking direction were fitted with a pair of end plates comprising 1-cm-thick stainless steel plates. A current collector plate comprising a 2-mm thick copper plate whose surface was plated with gold and an insulator plate were disposed between each end plate and each separator at the outermost part. The current collector plate was disposed on the separator side, while the insulator plate was disposed on the end plate side. In this state, the pair of end plates was clamped with bolts, nuts, and springs to pressurize the MEAs and the respective separators.

In the above manner, a DMFC stack with a size of 12×12 cm was produced.

### (f) Production of Fuel Cell System

Using the DMFC stack, a fuel cell system was produced.

The amounts of air and fuel supplied to the cell stack were precisely adjusted to heighten the accuracy of the experiment. The air was not supplied by a common air pump, and instead, compressed air supplied from a high pressure air cylinder was supplied to the cell stack by using a massflow controller of Horiba, Ltd. to adjust the flow rate thereof. The fuel was supplied by using a precision pump (personal pump NP-KX-100 (product name)) available from Nihon Seimitu Kagaku Co. Ltd.

The air-blowing device used as the cooling device was a model 412JHH available from ebm-papst of the United States.

The precision pump serving as the fuel supply device, the mass flow controller serving as the air supply device, and the air-blowing device serving as the cooling device were connected to a personal computer serving as the controller. Using the controller, the start-up and shut-down of the respective devices and the adjustment of the flow rates were controlled.

The liquid-collecting unit used was a rectangular parallelepiped shaped container made of polypropylene and having a 5-cm square bottom face and a height of 10 cm. A porous film TEMISH (gas-liquid separation film) available from Nitto Denko Corporation was thermally welded to the top face of the liquid-collecting unit.

The inlet of the fuel flow channel of each cell and the fuel pump were connected by using a silicone tube and a branched pipe. Likewise, the outlet of the fuel flow channel of each cell and the liquid-collecting unit were connected by using a silicone tube and a branched pipe. Also, the inlet of the air flow channel of each cell and the massflow controller, and the outlet of the air flow channel and the liquid-collecting unit were also connected by using a silicone tube and a branched pipe.

The cell stack was placed in a plastic casing in the form of a rectangular tube. The inner faces of the top and bottom of the casing were brought into contact with the upper and lower faces of the cell stack (one end face and the other end face of the cell stack in the stacking direction) to prevent the air supplied by the air-blowing device from flowing therebetween. Also, a gap of 10 mm was provided between the inner faces of both sides of the casing and both side faces of the cell stack to form an air flow path. The air-blowing device was disposed so as to supply a flow of air toward the opening of the casing.

The secondary battery used was a battery pack comprising seven lithium ion batteries CGR26650 connected directly. The battery pack was fitted with a voltage sensor serving as the remaining capacity detector, so that voltage information was sent to the personal computer serving as the controller. Based on the relationship between the voltage and the remaining capacity of the battery pack which were measured in advance, the personal computer was configured to determine the remaining capacity from the voltage. The remaining capacity and the rate of change of the remaining capacity were measured every 0.5 second, and the average value in 10 seconds was calculated. Based on the average value obtained in this manner, a control mode and a power generation mode were selected.

The DMFC cell stack was connected to the battery pack via a DC-DC converter. The DC-DC converter was connected to the personal computer serving as the controller such that the input voltage of the DC-DC converter, i.e., the output voltage of the cell stack, could be adjusted from the personal computer.

### (g) Setting of Power Generation Mode and Control Mode of Fuel Cell

### (i) Power Generation Mode

The following three power generation modes of the DMFC stack (fuel cell) were set.

Strong mode: cell stack voltage 8 V

Middle mode: cell stack voltage 9 V

Weak mode: cell stack voltage 11 V

Specifically, a signal was sent to the DC-DC converter from the personal computer serving as the controller such that the voltage of the cell stack was equal to the above-mentioned set value, in order to control the DC-DC converter. The DC-DC converter was fitted with a current sensor (not shown) to measure the output current of the cell stack during power generation, and the measured current was sent to the personal computer as the controller.

The net output of the cell stack in an early stage of power generation (30 minutes after the start of power generation) in each power generation mode, i.e., the output value obtained by subtracting the power consumed by the fuel supply device, the air supply device, the cooling device, and the controller from the output of the fuel cell stack, is as follows.

Strong mode: 100 W

Middle mode: 52 W

Weak mode: 0 W

The personal computer as the controller determined the amounts of fuel and air supply by multiplying the value measured by the current sensor by a set stoichiometric ratio, and controlled the precision pump and the mass flow controller. The fuel stoichiometric ratio was set to 1.5, and the air stoichiometric ratio was set to 2.

The output terminal of the fuel cell system was connected to an electronic load unit “PLZ164WA” (available from Kikusui Electronics Corporation) instead of an actual electrical device, and the fuel cell system was operated while the output was changed as appropriate.

### (ii) Capacity Threshold Value and Control Mode

The capacity threshold values for switching the power generation modes were provided with hysteresis to prevent the hunting phenomenon. That is, the threshold value (the lower threshold value) for increasing the output from that in the current power generation mode was set to a value that was always 2% smaller than the threshold value (the upper threshold value) for decreasing the output from that in the current power generation mode. For example, the lower threshold value for changing from the middle mode to the strong mode was set to a value that was always 2% smaller than the upper threshold value for changing from the strong mode to the middle mode.

The median value of the upper threshold value and the lower threshold value is referred to as the median threshold value.

The capacity threshold values and the threshold values of the rate of change were set as shown in FIG. 4b.

(A) When the rate of change of the remaining capacity was in the range of less than −50%/h, the median capacity threshold value between the weak mode and the middle mode was set to 95%, and the median capacity threshold value between the middle mode and the strong mode was set to 80%.

(B) When the rate of change of the remaining capacity was in the range of −50%/h or more and less than 0%/h, the median capacity threshold value between the weak mode and the middle mode was set to 90%, and the median capacity threshold value between the middle mode and the strong mode was set to 65%.

(C) When the rate of change of the remaining capacity was in the range of 0%/h or more, the median capacity threshold value between the weak mode and the middle mode was set to 65%, and the median capacity threshold value between the middle mode and the strong mode was set to 50%.

### Comparative Example 1

Using the same fuel cell system as that of Example 1, the threshold values of the remaining capacity were set as follows, irrespective of the rate of change of the remaining capacity. It should be noted that in the same manner as in Example 1, hysteresis was set such that the lower threshold value was always 2% smaller than the upper threshold value.

The median capacity threshold value between the weak mode and the middle mode was set to 80%, and the median capacity threshold value between the middle mode and the strong mode was set to 50%.

### [Evaluation]

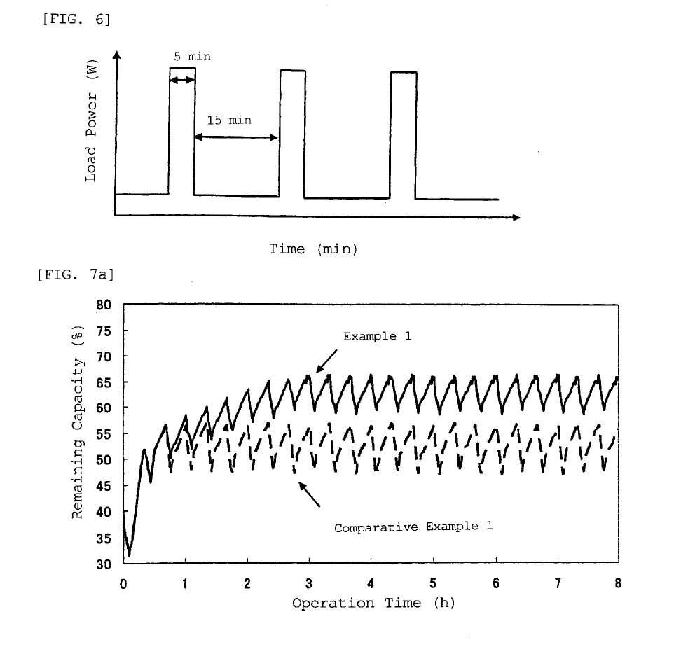

In order to clarify the advantageous effects of the invention, the fuel cell system was connected with a load and used for 8 hours, and the change of the remaining capacity of the secondary battery was measured. Load power patterns simulating actual load power variations, as shown in FIG. 6, were programmed into the load connected to the fuel cell system. In each of the following two patterns, an 8-hour measurement was made for cases where the initial remaining capacity of the secondary battery was 40% and 70%.

Pattern A: 150 W for 5 minutes and 30 W for 15 minutes

Pattern B: 100 W for 5 minutes and 30 W for 15 minutes

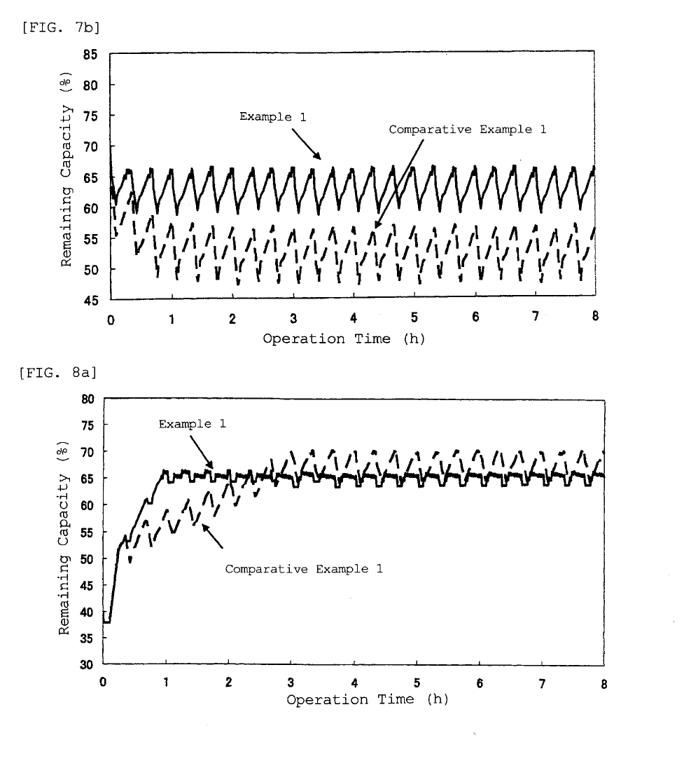

FIG. 7a shows the measurement results of change of remaining capacity in Pattern A for the fuel cells of Example 1 and Comparative Example 1 when the initial remaining capacity of the secondary battery is 40%. Also, FIG. 7b shows the measurement results of change of remaining capacity in Pattern A when the initial remaining capacity of the secondary battery is 70%.

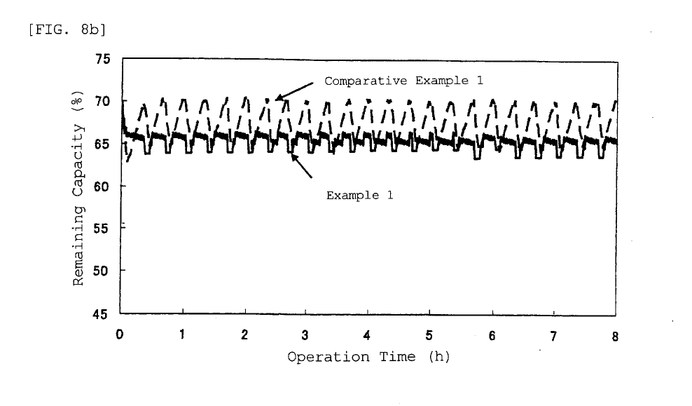

FIG. 8a shows the measurement results of change of remaining capacity in Pattern B for the fuel cells of Example 1 and Comparative Example 1 when the initial remaining capacity of the secondary battery is 40%. Also, FIG. 8b shows the measurement results of change of remaining capacity in Pattern B when the initial remaining capacity of the secondary battery is 70%.

As can be understood from the respective figures, the remaining capacity of the secondary battery converges onto a certain remaining capacity while repeating the cycle of decreasing at large load and increasing at small load. It took approximately 2 hours for the remaining capacity to converge.

In order to quantify the width and frequency of the repeated charge/discharge of the secondary battery, the standard deviation of the remaining capacity after the lapse of 2 hours until the lapse of 8 hours was calculated. Table 1 shows the results.

TABLE 1

| | Initial | | |
|---|---|---|---|
| | remaining | | Comparative |
| Load pattern | capacity | Example 1 | Example 1 |
| Pattern A | 40% | 2.1 | 2.6 |
| Pattern A | 70% | 2.0 | 2.5 |
| Pattern B | 40% | 0.9 | 2.2 |
| Pattern B | 70% | 0.8 | 1.9 |

The results of Example 1 and Comparative Example 1 are compared below. First, after the lapse of 2 hours, i.e., after the remaining capacity converged, the variation of the remaining capacity is clearly smaller in Example 1 than in Comparative Example 1. This indicates the charge/discharge depth of the lithium ion battery is reduced. In particular, in Pattern B, the standard deviation of the remaining capacity in Example 1 is reduced to approximately ½ of the standard deviation of the remaining capacity in Comparative Example 1, and it is thus thought that the deterioration of the secondary battery due to charge/discharge cycles is significantly reduced.

Also, in Example 1, the remaining capacity after the lapse of 2 hours converges on approximately 65% regardless of the initial remaining capacity and the load pattern, whereas in Comparative Example 1, the remaining capacity converges on approximately 50% or approximately 70%, depending on the load pattern. In Comparative Example 1, the threshold values of the remaining capacity are constant; thus, when the load is large, the remaining capacity converges on a value close to the threshold value between the middle mode and the strong mode, and when the load is small, the remaining capacity converges on a value close to the threshold value between the weak mode and the middle mode. There is a problem in that as the converged value of the remaining capacity becomes larger, the secondary battery is more likely to deteriorate after the fuel cell system is shut down and not in operation. Also, as the converged value of the remaining capacity becomes smaller, it is more difficult to use the secondary battery at a large load upon the next start-up, and it is necessary to start it by charging it. Therefore, in usage modes in which start-up and shut-down are frequently repeated, deterioration due to charge/discharge cycles is promoted.

On the other hand, in the case of Example 1, since the system can be shut down with the remaining capacity being constantly medium, the deterioration of the secondary battery due to storage and deterioration due to charge/discharge cycles can be reduced.

As described above, the invention can reduce the charge/discharge depth of the secondary battery and constantly keep the remaining capacity appropriate upon shut-down, thereby making it possible to reduce the deterioration of the secondary battery and extend the life of the fuel cell system.

### INDUSTRIAL APPLICABILITY

The fuel cell system and control method according to the invention are useful when applied to, for example, the power source for portable small electronic devices such as notebook personal computers, cellular phones, and personal digital assistants (PDAs) or the portable power source in outdoor leisure activities such as camping. The fuel cell system and control method according to the invention are also applicable to uses as the power source for electric scooters and the like.

Although the invention has been described in terms of the presently preferred embodiments, it is to be understood that such disclosure is not to be interpreted as limiting. Various alterations and modifications will no doubt become apparent to those skilled in the art to which the invention pertains, after having read the above disclosure. Accordingly, it is intended that the appended claims be interpreted as covering all alterations and modifications as fall within the true spirit and scope of the invention.

### REFERENCE SIGNS LIST

1: Fuel Cell Stack, 2: Fuel Supply Device, 3: Air Supply Device, 4: Fuel Tank, 5: Liquid-collecting unit, 6: Cooling Device, 7: Controller, 8: Secondary Battery, 9: DC-DC Converter, 10: Battery Remaining Capacity Detector, 21: Fuel Cell, 22: Polymer Electrolyte Membrane, 23: Anode, 24: Cathode, 25: Anode Catalyst Layer, 26: Anode Water-Repellent Layer, 27: Anode Porous Substrate, 28: Anode Diffusion Layer, 29: Cathode Catalyst Layer, 30: Cathode Water-Repellent Layer, 31: Cathode Porous Substrate, 32: Cathode Diffusion Layer, 33: Anode-Side Separator, 34: Cathode-Side Separator, 35A, B: Gasket, 36A, B: End Plate

1. A method for controlling a fuel cell system including a fuel cell and a secondary battery for storing output power of the fuel cell,
the method comprising the steps of:
detecting a remaining capacity of the secondary battery;
determining a rate of change of the remaining capacity, where the rate of change is defined as positive when it increases and negative when it decreases; and
changing an operation state of the fuel cell based on the remaining capacity and the rate of change.

2. The method for controlling a fuel cell system in accordance with claim 1, wherein the step of changing the operation state is a step of switching the operation state between a plurality of power generation modes based on the remaining capacity and the rate of change.

3. The method for controlling a fuel cell system in accordance with claim 2,
wherein the power generation modes are switched based on a result of comparison between the remaining capacity and at least one reference value, and
control modes each having the at least one reference value for controlling the operation state of the fuel cell are switched based on a result of comparison between the rate of change and at least one predetermined value.

4. The method for controlling a fuel cell system in accordance with claim 3,
wherein the remaining capacity is divided by N of the at least one reference value into (N+1) ranges where N is an integer of 1 or more, and
each of (N+1) of the power generation modes is set for each of the (N+1) ranges of the remaining capacity such that amounts of power generated by the power generation modes increase as the remaining capacity decreases.

5. The method for controlling a fuel cell system in accordance with claim 4,
wherein the rate of change is divided by M of the at least one predetermined value into (M+1) ranges where M is an integer of 1 or more, and
each of (M+1) of the control modes is set for each of the (M+1) ranges of the rate of change such that the respective (N+1) reference values of the control modes decrease as the rate of change increases.

6. The method for controlling a fuel cell system in accordance with claim 1, wherein the remaining capacity is detected based on a voltage of the secondary battery.

7. The method for controlling a fuel cell system in accordance with claim 6, wherein the voltage of the secondary battery is detected based on a terminal voltage of a capacitor connected to the secondary battery in parallel.

8. The method for controlling a fuel cell system in accordance with claim 1,
wherein the step of changing the operation state is a step of changing a control mode for controlling the operation state of the fuel cell continuously or in stages, and
the fuel cell is more likely to be operated in a power generation mode for generating a larger amount of power as an absolute value of the positive rate of change decreases or as an absolute value of the negative rate of change increases.

9. The method for controlling a fuel cell system in accordance with claim 8, wherein the power generation mode is changed continuously or in stages such that the amount of power generation increases as the remaining capacity decreases.

10. A fuel cell system comprising:
a fuel cell;
a secondary battery for storing output power of the fuel cell;
a remaining capacity detector for detecting a remaining capacity of the secondary battery; and
a controller for determining a rate of change of the remaining capacity, where the rate of change is defined as positive when it increases and negative when it decreases, and changing an operation state of the fuel cell based on the remaining capacity and the rate of change.

11. The fuel cell system in accordance with claim 10, wherein the controller is configured to switch the operation state between a plurality of power generation modes based on the remaining capacity and the rate of change.

12. The fuel cell system in accordance with claim 11, wherein the controller is configured to:
switch the power generation modes based on a result of comparison between the remaining capacity and at least one reference value; and
switch control modes, each having the at least one reference value for controlling the operation state of the fuel cell, based on a result of comparison between the rate of change and at least one predetermined value.

13. The fuel cell system in accordance with claim 12,
wherein the remaining capacity is divided by N of the at least one reference value into (N+1) ranges where N is an integer of 1 or more, and
each of (N+1) of the power generation modes is set for each of the (N+1) ranges of the remaining capacity such that amounts of power generated by the power generation modes increase as the remaining capacity decreases.

14. The fuel cell system in accordance with claim 13,
wherein the rate of change is divided by M of the at least one predetermined value into (M+1) ranges where M is an integer of 1 or more, and
each of (M+1) of the control modes is set for each of the (M+1) ranges of the rate of change such that the respective (N+1) reference values of the control modes decrease as the rate of change increases.

15. The fuel cell system in accordance with claim 10, wherein the controller changes a control mode for controlling the operation state of the fuel cell continuously or in stages such that the fuel cell is more likely to be operated in a power generation mode for generating a larger amount of power as an absolute value of the positive rate of change decreases or as an absolute value of the negative rate of change increases.

16. The fuel cell system in accordance with claim 15, wherein the controller changes the power generation mode continuously or in stages such that the amount of power generation increases as the remaining capacity decreases.
